(19) United States
(12) Patent Application Publication
(10) Pub. No.: US 2018/0211315 A1
(43) Pub. Date: Jul. 26, 2018

(54) METHODS AND SYSTEMS FOR HANDLING COMPLEX ORDERS

(71) Applicant: Chicago Board Options Exchange, Incorporated, Chicago, IL (US)

(72) Inventors: Anthony Montesano, Chicago, IL (US); Eileen C. Smith, Chicago, IL (US)

(73) Assignee: Chicago Board Options Exchange, Incorporated, Chicago, IL (US)

(21) Appl. No.: 15/697,079

(22) Filed: Sep. 6, 2017

Related U.S. Application Data
(63) Continuation of application No. 13/975,045, filed on Aug. 23, 2013, now abandoned.
(60) Provisional application No. 61/693,115, filed on Aug. 24, 2012.

(51) Int. Cl. G06Q 40/04

(52) U.S. Cl. CPC G06Q 40/04

(57) ABSTRACT

Systems and methods for determining a strategy to handle complex orders are disclosed. In one implementation, the system may include a trading platform, and a set of instructions to determine a complex orders strategy that includes whether to calculate a synthetic complex order book (COB) quote, and perform a COB enhanced execution, a spread flash, spread legging, spread linking, or any combination thereof to realize a price improvement. The system executes the complex orders strategy to obtain a strategy result determined to provide price improvement, and displays the complex orders strategy and the strategy result on a display device to the user.

### CROSS-REFERENCE TO RELATED APPLICATIONS

This application claims the benefit of U.S. Provisional App. No. 61/693,115, filed Aug. 24, 2012, wherein the entirety of the aforementioned application is hereby incorporated herein by reference.

### FIELD OF THE DISCLOSURE

The present disclosure relates to the trading of financial products. More specifically, the present disclosure relates to aspects of actively creating, disseminating, trading, and auctioning complex orders.

### BACKGROUND

A derivative is a financial security whose value is based, at least in part, on a value or characteristic of an underlying asset. Two exemplary and well known derivatives are options and futures.

An option is a contract that gives the contract holder a right, but not an obligation, to buy or sell an underlying asset at a specific price on or before a certain date. Generally, a party who purchases an option is referred to as the holder of the option and a party who sells an option is referred to as the writer of the option.

There are generally two types of options: call and put options. A holder of a call option receives a right to purchase an underlying asset at a specific price, i.e., the “strike price.” If the holder exercises the call option, the writer is obligated to deliver the underlying asset to the holder at the strike price. Alternatively, the holder of a put option receives a right to sell an underlying asset at a strike price. If the holder exercises the put option, the writer is obligated to purchase the underlying asset at the agreed upon strike price. When settlement includes the transfer of an underlying asset, the settlement is often referred to as physical settlement or in kind settlement. However, an underlying asset of an option need not be tangible and/or transferable property.

Options may also be based on more abstract market indicators, such as stock indices, interest rates, futures contracts, and other derivatives. In these cases, physical settlement may not be desired and/or possible. When physical settlement is not desired and/or possible, contracts may be “cash settled.” That is, rather than transferring the underlying asset, a cash payment is made to settle the contract. For example, using cash settlement, a holder of an index call option receives the right to “purchase” not the index itself, but rather a cash amount based on the value of the index multiplied by a multiplier, e.g., $100. For example, if a holder of an index call option exercises the option, the writer of the option must pay the holder the difference between the current value of the underlying index and the strike price multiplied by the multiplier.

Similar to options contracts, futures contracts may also be based on abstract market indicators. Futures contracts give a buyer of the future an obligation to receive delivery of an underlying commodity or asset on a fixed date in the future. Accordingly, a seller of the future contract is obligated to deliver the commodity or asset on the specified date for a given price.

Although futures contracts generally confer an obligation to physically deliver an underlying asset on a specified delivery date, the actual underlying asset need not change hands. Instead, futures contracts, like options contracts, may be cash settled. To cash settle a futures contract, the difference between a market price and a contract price of an underlying asset is paid by one investor to the other. Again, like options, cash settlement allows futures contracts to be created based on more abstract assets, such as market indices. To cash settle index futures, the difference between the contract price and the price of the underlying index (i.e., current value of market index) is exchanged between the investors. Derivatives such as options and futures may be traded over-the-counter (“OTC”), and/or on other trading facilities such as organized exchanges (e.g., Chicago Board Options Exchange Incorporated). OTC transactions are bilateral in nature and individual parties to a transaction are free to customize each transaction as they see fit. Platform-traded derivatives, such as exchange traded derivatives, are standardized and are settled using a clearing corporation that acts as an intermediary when a contract is exercised.

Orders to buy or sell derivatives are often completed as part of a greater overall trading strategy. For example, a trader might want to buy asset A and sell asset B, but only if both transactions are possible for a particular price or better. To accommodate these types of transactions, complex orders for a particular price (e.g., a complex limit order) also known as spread orders, are used. Complex orders are orders that consist of two or more legs or components. However, in order to execute a complex order, all of the legs must be executable for a combined price that is at or better than the complex order limit price. Because a complex order can be made up of any combination of legs and the legs may be various types of financial products (including, but not limited to, stocks, options, futures, swaps, bonds, etc.), the trading strategies that can be implemented via complex orders are diverse and ever growing. Moreover, trading exchanges (e.g., Chicago Board Options Exchange Incorporated) often keep different “books” for standard and complex orders. Generally, a book is a list of the orders resting at an exchange. A complex order book (“COB”) contains information regarding the complex orders resting at an exchange. When attempting to execute an incoming complex order, the exchange will check the COB for a contra order (an order that has the opposite position to the incoming order) to execute with the incoming complex order.

Additionally, when attempting to execute an incoming complex order, the exchange might check the standard order book (i.e., the book that contains information regarding non-complex orders) to determine if the individual legs of the complex order can be executed against standard orders resting in the standard order book. Again, it is important to note that even if the legs could be executed against orders resting in the standard order book, the complex order cannot execute unless all the legs can be executed and the sum cost of the execution of the legs is at or better than a limit price for the complex order.

Additionally, when attempting to execute an incoming complex order, the exchange might conduct an auction. For example, a complex order auction (“COA”) automates the order handling and execution process for certain complex orders while continuing to provide the potential for price improvement through an automated auction process. With COA, eligible marketable and near-marketable complex orders will initiate an auction for price improvement. At the expiration of the auction period, the order will either trade or be booked to the COB. An exemplary COA method and system can be found in U.S. Pat. No. 7,676,421, which is co-owned and incorporated by reference in its entirety into the present application.

However, even using the above described complex order execution mechanisms, executing incoming complex orders is often difficult. The disclosure contained herein provides multiple new and innovative mechanisms for achieving execution of complex orders.

### SUMMARY

Methods and systems for handling complex orders may comprise a configuration including a trading platform in direct or indirect communications through a network (e.g., the Internet) with a home exchange (e.g., Chicago Board Options Exchange) and away exchanges (e.g., NYSE ARCA, NYSE AMEX, the Boston Options Exchange, etc.). The trading platform includes a display device, a memory and a processor. The trading platform stores in the memory: bids, offers, and orders. The orders include option orders that include multi-legged and single-legged orders. The orders may include an incoming spread, and/or a resting spread.

The methods and systems for handling complex orders comprise ways to perform spread linking that includes receiving into a memory coupled to a processor of a trading platform a complex order including a requested price. Performing spread linking includes determining prices at which one or more respective exchanges can fill the complex order, where the prices include a home exchange price and at least one away exchange price. The exchanges include a home exchange and one or more away exchanges. When the home exchange price is equal to or better than the requested price and equal to or better than the at least one away exchange price, the complex order is executed at the home exchange. Alternatively, when the away exchange price is equal to or better than the requested price and better than the home exchange price, the complex order is routed to the away exchange for execution. When an order remainder results, the order remainder may rest at the home exchange or the away exchange, depending on the preferences of the user and/or the exchange.

The methods and systems for handling complex orders also comprise ways to perform spread legging. The method for performing spread legging determines whether one or more exchanges can fill the legs of an order. When the one or more exchanges can fill the legs, each of the legs are identified as home exchange executable legs executable by the home exchange or away exchange executable legs executable by the away exchange. The method for performing spread legging determines, for each of the away exchange executable legs, at least one of the one or more away exchanges offering a better leg price. The better leg price is a leg price better than the requested leg price for the leg and better than a leg price offered by the other one or more away exchanges. The method for performing spread legging includes executing the home exchange executable legs by the home exchange, and routing the away exchange executable legs to the respective one or more away exchanges offering the better leg price. The method for performing spread legging determines whether an order remainder results from execution of the home exchange executable legs and the away exchange executable legs, and when the order remainder results, rests the order remainder at the home or away exchange depending on the preferences of the users and/or the exchange.

The methods and systems for handling complex orders further include a way to perform spread flashing. Performing spread flashing includes determining for at least one of the legs of an order whether the displayed market price at the home exchange or an away exchange price at one or more away exchanges satisfies the requested leg price for one of the legs the order. When one of the one or more away exchanges can execute the leg at the away exchange price and the leg is not executable at the home exchange, the home exchange auctions the leg to local market participants. When at least one of the local market participants satisfy the away exchange price or offers a better price than the displayed market price for the leg, identified as a spread flash price, and when the displayed market price for the other legs displayed at the home exchange satisfy the requested leg price for the other legs, the order is executed at the home exchange. The home exchange executes the one leg at the spread flash price and executes the other legs at the respective displayed market price for the other legs.

The methods and systems for handling complex orders further include a way to perform a COB enhanced execution. Performing the COB enhanced execution includes determining whether trading a non-complex order depends on execution of a complex order as a precondition to trading the non-complex order, and executing the non-complex order against the complex order, when the complex order is determined to be a precondition to trading the non-complex order.

The methods and systems for handling complex orders comprise a way to calculate a synthetic complex COB quote. A synthetic COB quote is calculated to match or improve the best displayed market price for a leg of a resting COB order. The synthetic COB quote satisfies the net order price for the resting COB order when another leg of the resting COB order is executed against the best displayed market price for the other leg. The synthetic COB quote is displayed to market participants to attract simple orders that make the resting complex orders tradable.

### BRIEF DESCRIPTION OF THE DRAWINGS

FIG. 1 is a block diagram of an exemplary financial trading system that may be used to implement an embodiment of the present invention.

FIG. 2 is a schematic of a system configuration to implement one embodiment of the present invention.

FIG. 3 is one implementation of a logic flow that a system may take to perform spread linking.

FIG. 4 is one implementation of a logic flow that a system may take to perform spread legging.

FIG. 5 is one implementation of a logic flow that a system may take to perform spread flash.

FIG. 6 is one implementation of a logic flow that a system may take to perform a COB enhanced execution.

FIG. 7 is one implementation of a logic flow that a system may take to calculate synthetic COB quotes.

FIG. 8 is an illustrative example of an embodiment of a general computer system.

### DETAILED DESCRIPTION

The present disclosure is directed to methods and systems related to the trading of complex orders. According to one embodiment of the present invention, the methods and systems described herein are integrated into known computerized financial trading systems, such as computerized systems that are currently used by financial exchanges (e.g., Chicago Board Options Exchange Incorporated). According to other embodiments of the present invention, the methods and systems described herein can be implemented utilizing computerized financial systems that are separate from systems that are currently used by financial exchanges or by utilizing a combination of financial exchange and non-financial exchange systems.

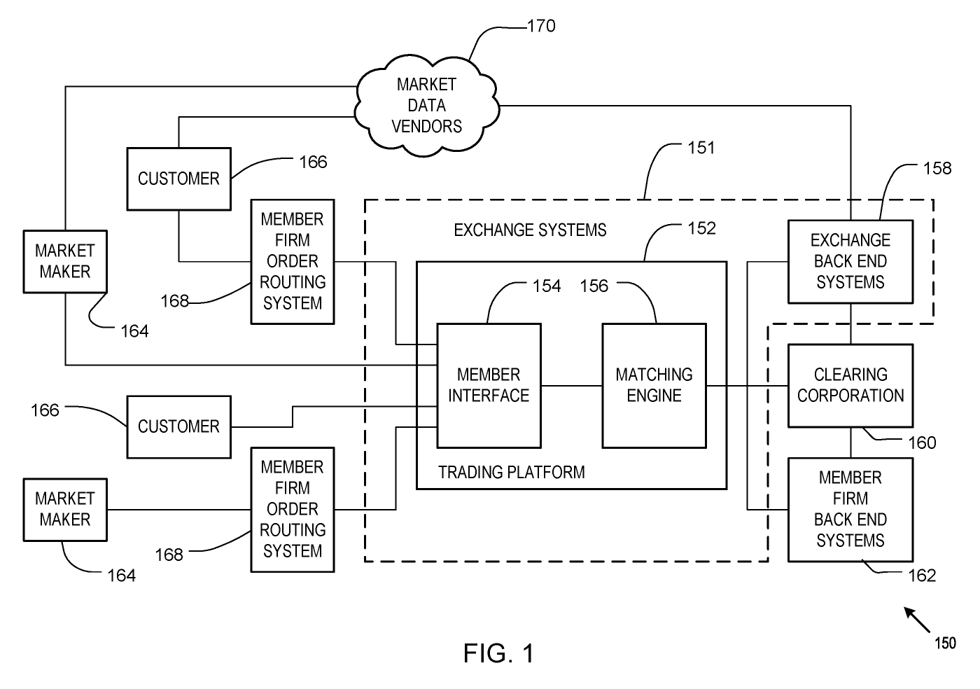

FIG. 1 shows an exemplary financial trading system 150. Financial trading system 150 includes financial exchange components, as well as components operated by non-exchange entities that access the financial exchange. The financial exchange components are shown within the dashed lines 151. Components outside the dashed lines are operated by non-exchange entities. Electronic communications within financial trading system 150 may be achieved using a variety of known mediums, including: LANs, WANs, and the Internet.

The exchange components of the financial trading system 150 include a computer implemented trading platform 152 (that includes, but is not limited to, member interface 154 and matching engine 156) and computer implemented exchange backend systems 158. Member interface 154 provides an electronic interface for receiving trading messages (e.g., bids, offers, quotes, orders, and trading instructions) from the computers or other electronic devices of traders or other entities transacting business at the financial exchange, or any combination thereof. The member interface 154 may be a graphical user interface (“GUI”) and other software components operating on a computer configured to perform trading functionality. Additionally, according to the financial trading system 150, the member interface 154 screens analyzes received electronic trading instructions for proper format and information, and, if deemed execution eligible, routes the trading instruction to the appropriate matching engine 156.

Matching engine 156 provides an electronic mechanism for matching contra-position bids and offers that are submitted to the financial exchange by traders or other entities transacting business at the financial exchange. While financial trading system 150 shows a single matching engine 156, multiple matching engines may be included in a trading platform 152. Multiple matching engines may work independently or cooperatively depending on various factors related to the business of the financial exchange. For example, different exchange traded products (e.g., stock, options, futures, etc.) may utilize different matching engines. The matching engine 156 executes trades by pairing contra orders. Further, according to some financial trading systems, non-marketable orders are placed in an electronic order book. An electric order book may be implemented using known computer hardware in combination with a database product.

After a trade is executed, matching engine 156 sends information related to the executed trade to the exchange backend systems 158, which are used in the process of settling trades that have been executed at the financial exchange. Further, the matching engine 156 sends information related to the executed trade to the member firm backend systems 162. According to some examples of financial trading systems, the matching engine 156 also updates the electronic order book based on executed transactions.

The non-exchange components of financial trading system 150 include clearing corporation systems 160, and member firm backend systems 162. The clearing corporation systems 160 are used in the process of settling trades that have been executed at the financial exchange. An example of a clearing corporation is The Options Clearing Corporation, which is an equity derivatives clearing organization. The member firm backend systems 162 are used by the entities conducting business at the financial exchange to receive settlement information regarding their transactions.

According to the present exemplary financial trading system, the computer implemented trading platform 152 can be accessed in a variety of ways by entities conducting business at the financial exchange. For example, market makers may access the computer implemented trading platform 152 through market maker computers 164 that are in electronic communication with the member interface 154. Utilizing the market maker terminals, electronic trading messages (e.g., bids, offers, quotes, orders, trading instructions) may be sent to the computer implemented trading platform 152. These messages may include instructions for trading complex orders. Alternatively, the electronic trading messages (e.g., bids, offers, quotes, orders, trading instructions) may be routed through a member firm order routing system 168.

Further, according to the present exemplary financial trading system, a non-member entity wanting to transact business at the financial exchange can enter the non-member entity's trading instructions using a customer computer 166. However, these trading instructions must be routed through a member firm order routing system 168. The member firms order routing systems 168 transmits the electronic trading instructions to the member interface 154.

The exchange backend systems 158 may, according to some implementations of financial trading systems, perform a number of functions. For example, exchange backend systems 158 may perform operations related to contract definition and listing data. Additionally, the exchange backend systems may transmit information regarding orders (including, but not limited to complex orders) to market data vendors 170, perform operations related to the performance of underlying assets upon which derivatives are based, determine appropriate contract settlement values, and supply final settlement data to the clearing corporation systems 160 and the member firm backend systems 162.

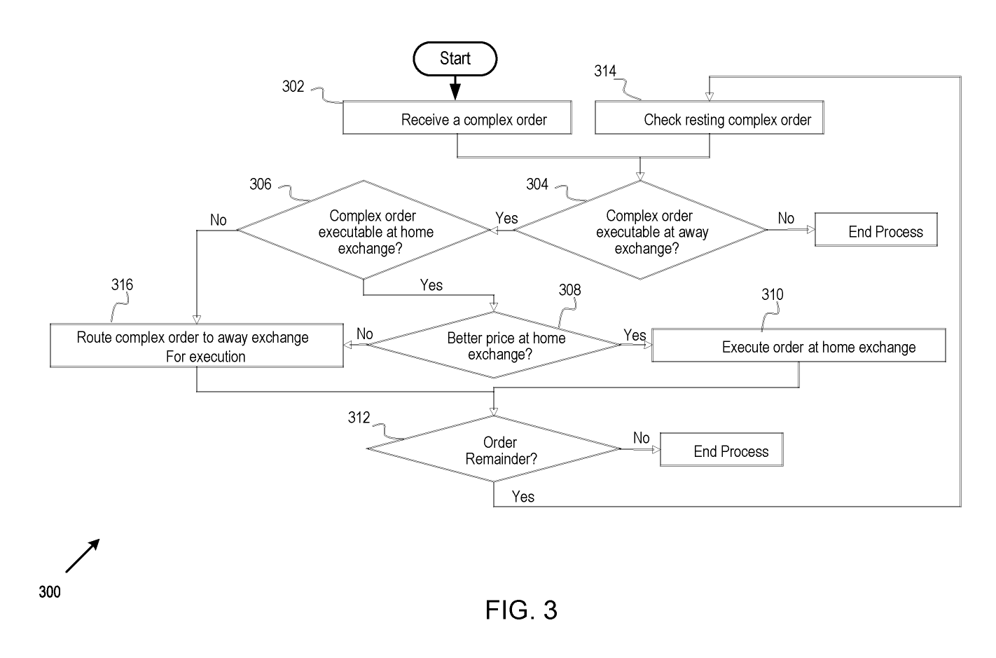

According to the present disclosure, complex orders can be processed in a number of ways that increase the likelihood that the complex order will be executed. As described in FIG. 3, complex order linking is a process by which a complex order that has been submitted to an exchange, might be routed, in totality (i.e., all of the complex order legs), to another exchange for execution. This might occur, for example, if the complex order is not marketable at the home exchange (i.e., the exchange where the complex order was originally submitted), if the complex order can be executed for a better price at an away exchange (i.e., any exchange that is not the home exchange), or if the originator of a complex order instructs the home exchange to route the order to an away exchange.

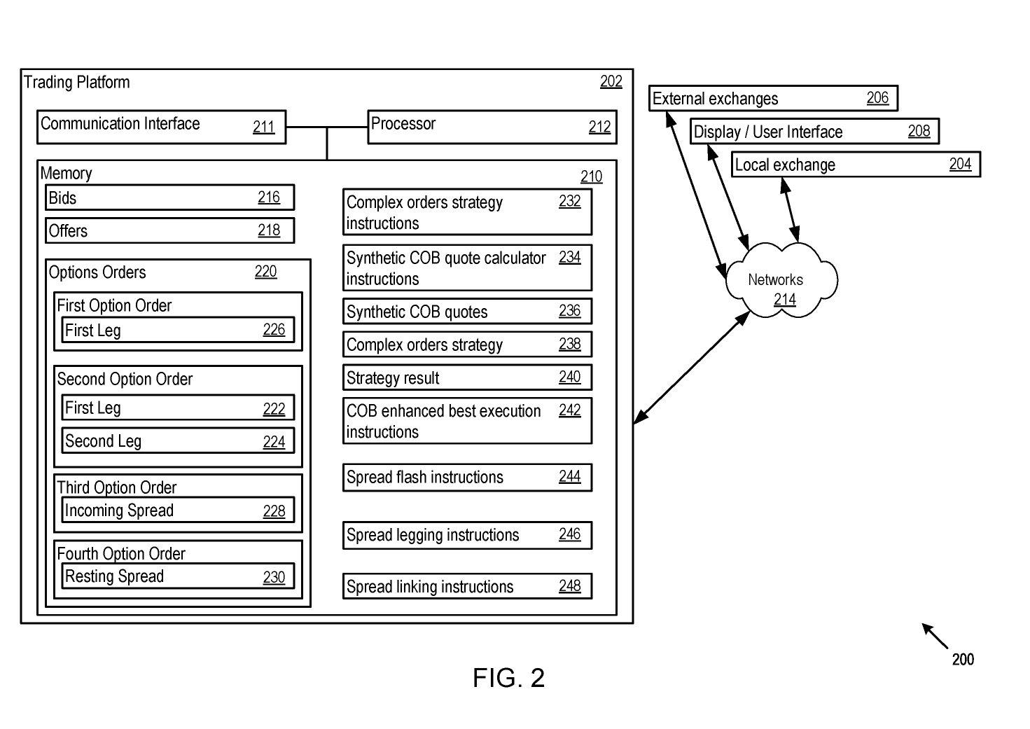

FIG. 2 is a schematic of an example of a system configuration 200 that may implement one embodiment of the present invention. The system configuration 200 includes a trading platform 202 the system) in communications through a network 214 (e.g., the Internet) with a home exchange 204 (e.g., CBOE) and away exchanges 206. The trading platform 202 may include a display device 208 which may display a user interface, a memory 210, communications interface 211, and a processor 212. The trading platform 202 uses the memory 210 to store trading instructions (including but not limited to: bids 216 to buy all or a component part of an order, offers 218 to sell all or a component part to fill an order, and options orders 220). The exchange coordinates the activities of buyers and sellers so that “bids” to buy can be matched with “offers” to sell orders. The option orders 220 may be multi-legged 222, 224 (i.e., complex) and single-legged 226 orders. The option orders 220 may include an incoming spread 228, and/or a resting spread 230 on a COB. The memory 210 may store a set of computer instructions, including complex orders strategy instructions 232 such as a synthetic COB quote calculator 234 that calculates synthetic COB quotes 236 for legs of a spread. Utilizing the synthetic COB quote calculator, the system 202 calculates a synthetic price (improved price) for one or more legs of a complex order to improve the displayed market. The trading platform 202 uses the complex orders strategy instructions 232 to determine a complex orders strategy 238 to use to obtain a strategy result 240, (e.g. faster execution or improved price). The complex orders strategy 238 includes determining whether to calculate a synthetic COB quote 236. The processor 212 executes the complex orders strategy 238 to obtain the strategy result 240, and may display the complex orders strategy 238 and the strategy result 240 on the display device 208, depending on user or system defined preferences.

The complex orders strategy instructions 232 includes: synthetic COB quotes calculator instructions COB enhanced execution instructions 242, spread flash instructions 244, spread legging instructions 246, spread linking instructions 248, or any combination thereof. The set of instructions 232 determine whether to and in what combination to perform COB enhanced execution, spread linking, or spread legging, or spread flash, or any combination thereof. As discussed in further detail below, the COB enhanced execution instructions 242 uses unfilled single-legged option orders to fill component legs of a multi-legged options order. As discussed in further detail below, the spread flash instructions 244 auction a leg of a multi-legged option order to local market participants.

### Spread Linking

The system uses spread linking for marketable spreads that cannot be executed at a home exchange (e.g., CBOE) in order to link to away exchanges that support complex orders and that can fill all legs of the complex order (according to the appropriate ratio). The system uses spread linking for both incoming spreads (e.g., after a COA) and resting spreads (e.g., at the end of a COA, the system may rest all spreads in COB for a short time before linking the spreads away). To determine the marketability of a complex order at an away exchange, the system 202 may monitor both single exchange leg markets as well as any complex order books available to the home exchange (e.g., CBOE). The system 202 may, according to system or user defined options, cause orders to be linked if the away market is better, even in those instances where the complex order is marketable at the home exchange CBOE). The system 202 may offer the best-execution option on an order-by-order basis by providing a field for the execution instruction, or by firm/class/correspondent/log-in parameter.

Spread linking allows the system to fill each order at a best/better available price, where a best/better prices is shown at an away exchange(s). The legs of the complex order priced in the aggregate must be fillable on the exchange(s) to which the complex order is routed for fulfillment. For example, where a complex order includes a first leg to buy and a second leg to sell, and an away exchange shows an offer at two dollars for the first leg, a one dollar bid for the second leg; the net price for the complex order at the away exchange is one dollar.

An example of spread linking might involve sending a multi-leg complex order to a home exchange to be filled. The system receives the order and routing to order a trade engine for processing. If the exchange is unable to trade the order at the home exchange or if there is a better price available on one or more away exchanges the home exchange sends the complex order to the one or more away exchanges. In an embodiment of the present invention, the order is sent to an away exchange as an immediate or canceled order (IOC). At the away exchange the linked order may be totally or partially filled. According to an embodiment of the present invention, the linked order (i e the order sent to the away exchange for execution) is an all-or none order (“AONO”). If the linked order is not fully executed a remainder may either rest at the home or away exchange, according to either system or user defined parameters. Upon receipt of the fill notice from the away exchange the fill notice is sent to the customer.

According to an embodiment of the present invention, an order sent to an away exchange, (i.e., “a linked order”), may be different from the original customer order. For example, the linked order may be a sub (child) order of the customer (parent) order. The present invention may use spread linking for both complex and non-complex orders.

FIG. 3 is a flow diagram of an embodiment of the present invention that performs spread linking. The steps depicted in FIG. 3 may be implemented by the system shown in FIG. 2. At step 302, the system receives a complex order. At step 304 the system determines if the complex order is executable at an away exchange. If the complex order is not executable at an away exchange, the process ends. If the complex order is executable at an away exchange, the process continues at step 306. At step 306, the system determines if the complex order is executable at a home exchange. If the complex order is executable at a home exchange, at step 308 the system determines if the better executing price is at the home exchange. If the better execution price is at a home exchange, at step 310 the system executes the complex order at the home exchange. If the better execution price is at an away exchange, at step 316 the system routes the complex order to an away exchange for execution. According to an embodiment of the present invention, upon execution of a complex order routed to an away exchange a fill notice and/or remainder is sent from the away exchange to the home exchange. At step 312, the system determines if a remainder exists. If a reminder does not exist, at step 314 the system performs a check of all resting complex orders (e.g., complex orders on the COB) and begins the process again for each resting order. When a remainder exists (312), the system 202 may execute the remainder either locally (home exchange—e.g., CBOE) or use an away exchange, or the remainder rests at the home exchange (314), or based on historical information determine where to execute the remainder.

Table 1 shows the steps, according to an embodiment of the present invention, the system may use when a customer chooses not to use spread linking as described above.

TABLE 1
Customer does not choose best-execution

| | |
|---|---|
| 1) | AXX1 (Exchange) market for ABC Oct40c 2.00-2.20, |
| | size 100 × 100. |
| 2) | AXX1 market for ABC Oct40p 1.00-1.20, size 100 × 100. |
| 3) | AXX1 market DSM a complex order consisting of 2 legs - sell ABC |
| | Oct40c and sell ABC Oct 40p in 2:1 ratio is 5.60, size 50 (based |
| | on above markets). |
| 4) | AXX1 resting COB order to sell ABC Oct40c and sell ABC Oct40p |
| | in 2:1 ratio, 2 times at 5.59. |
| 5) | CBOE market for ABC Oct40c 2.00-2.21, size 100 × 100. |
| 6) | CBOE market for ABC Oct40p 1.00-1.20, size 100 × 100. |
| 7) | Home exchange (e.g., CBOE) to sell ABC Oct40c and sell Oct40p |
| | in 2:1 ratio is 5.62, size 50. |
| 8) | CBOE COB order to sell ABC Oct40c and sell ABC Oct40p in 2:1 |
| | ratio, 6 times at 5.60. |
| 9) | CBOE receives strategy order to buy 20 ABC Oct40c and buy 10 |
| | Oct40p for $5.61 (2:1, 10 times, limit price per unit 5.61. |
| 10) | COA begins, and ends with 1 response to sell 1 at 5.61. |
| | 6 Units execute against CBOE COB at 5.60, 1 unit against COA |
| | auction response at 5.61, leaving 3 units that are not |
| | marketable at CBOE but are marketable against AXX1 |
| | COB and DSM. |
| 11) | Remaining 3 units are booked for 5 seconds. |
| 12) | If not executed after 5 seconds, away markets are checked again. If |
| | no change, 3 units are linked to AXX1 where 2 execute against |
| | AXX1 COB at 5.59 and 1 against AXX1 DSM at 5.60. |
| 13) | Note if AXX1 DSM was 5.62 or higher, CBOE would only have |
| | linked 2 units, since that would have been the quantity marketable at |
| | AXX1 COB, and booked the remaining 1 unit. |

Table 2 shows the steps the system may use if spread linking is used to execute an order.

TABLE 2
Customer chooses best-execution

Logic steps 1-10 are the same as shown in Table 1.
11) 2 units are linked to AXX1 at 5.59, 6 units execute against CBOE
COB at 5.60, and 2 units are linked to AXX1 at 5.60.

### Spread Legging

According to an embodiment of the present invention, the system uses spread legging to link individual leg of a complex order to an away exchange(s) when the (202) away exchange's leg quote renders the complex order marketable. Spread legging may be used in executing both incoming and resting complex orders. According to one embodiment of the present invention, the system may book all complex orders prior to performing the spread linking process. Spread legging is similar to spread linking. However, in spread linking each leg of a complex order may be routed to an exchange for execution separate from each other leg. According to an embodiment of the present invention, the system monitors home and away exchange quotes to determine if each of the legs of a complex order can be executed at one or more exchanges in an away that satisfies the complex order price. If the execution of the legs would satisfy the price, the complex order is broken into simple single-leg orders that are executed at the home and/or away exchanges.

According to an embodiment of the present invention, the system may send an order or leg (or both) to those away exchanges that trade spreads electronically. According to an embodiment of the present invention, the system may send a notice regarding the order, or leg (or both) to those away exchanges that do not trade spreads electronically.

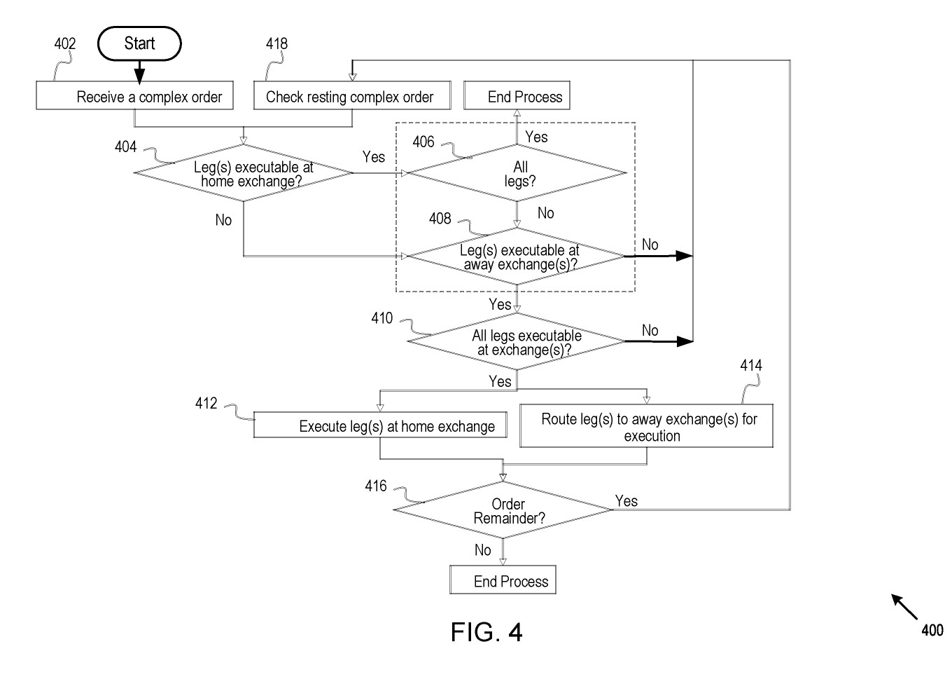

FIG. 4 is a flow diagram illustrating one embodiment of the present invention. FIG. 4 shows at step 402, the system receives a complex order. At step 404, the system determines whether each of the legs of the complex order may be executed at the home exchange. If one or more legs of the complex order are executable at the home exchange, the system, at step 406, determines if all of the legs of the order are executable. If the legs are all executable the process ends. If the system determines at step 404 that none of the legs are executable at the home exchange or the outcome of step 406 is that not all of the legs are executable at the home exchange, the process continues at step 408, where the system determines if one or more of the legs are executable at away exchanges. If not, the process begins again by performing the analysis on resting orders at step 418. If one or more legs of the complex order are executable at any away exchange, the process continues at step 410 where it is determined if all of the legs of the complex order are executable at the home and away exchanges. If not all of the legs are executable, the process beings again by performing the analysis on resting orders at step 418. If all the legs are executable, the appropriate legs of the order are routed to the home exchange for execution at step 412 and the appropriate legs of this order are returned to one or more away exchanges for execution at step 414.

According to one embodiment of the present invention, the system may not perform price comparisons between the leg(s) of a complex order that are executable at both home and away exchanges. Rather, according to this embodiment of the home exchange is given preference so long as the net price of the complex order is satisfied. According to another embodiment of the present invention, the system checks the prices shown by the away exchanges for each of the legs of the order, including legs that are executable at the home exchange, and executes the legs at the best available price regardless of the exchanges being home or away. For example, a first leg of a two-legged complex order is executable at an away exchange and the second leg is executable at the home exchange for a combined net price that satisfies the complex order. However, in the event an away exchange shows a better price for the second leg, i.e., the leg that is executable at the home exchange, the home exchange may forward the second leg to the other away exchange for execution at a better price. Returning to the description of FIG. 4, at step 416, the process determines if an order remainder exists. If an order remainder is present, it is booked and the process continues at step 418, if not the process ends.

Table 3 and 4 show examples of steps the system may use to execute an order utilizing spread legging, as described above.

TABLE 3
Legging at the end of a COA

| | |
|---|---|
| 1) | AXX1 (Away exchange) offer for ABC Oct40c is 2.20, size 100. |
| 2) | AXX1 offer for ABC Oct40p is 1.27, size 100. |
| 3) | AXX2 offer for ABC Oct40c is 2.18, size 2. |
| 4) | AXX2 offer for ABC Oct40p is 1.27, size 100. |
| 5) | CBOE offer for ABC Oct40c is 2.21, size 100. |
| 6) | CBOE offer for ABC Oct40p is 1.20, size 100. |
| 7) | Local market (e.g., CBOE) (DSM) to sell ABC Oct40c and sell |
| | Oct40p in 2:1 ratio is 5.62, size 50, which is single-exchange |
| | NBBO. |
| 8) | CBOE COB order to sell ABC Oct40c and sell ABC Oct40p in 2:1 |
| | ratio, 6 times at 5.60. |
| 9) | CBOE receives strategy order to buy 20 ABC Oct40c and buy 10 |
| | Oct40p for $5.61 (2:1, 10 times, limit price per unit 5.61. |
| 10) | COA begins, and ends with 1 response to sell 1 at 5.61. |
| | Units execute against CBOE COB at 5.60, 1 unit against COA |
| | auction response at 5.61, leaving 3 units that are not marketable at |
| | CBOE but are marketable against CBOE Oct40p offer of 1.2 and |
| | away Oct40c offers. |
| 11) | Remaining 3 units are booked for 5 seconds. |
| 12) | If not executed after 5 seconds, away markets are checked |
| | again. If no change, 3 contracts are executed against the CBOE |
| | Oct40p offer of 1.20, 2 contracts in the Oct40c are linked to AXX2 |
| | to buy at 2.18 and 4 to AXX1 at 2.20. |

TABLE 4
Legging out of the COB

| | |
|---|---|
| 1) | AXX1 offer for ABC Oct40c is 2.25, size 100. |
| 2) | AXX1 offer for ABC Oct40p is 1.20, size 100. |
| 3) | AXX2 offer for ABC Oct40c is 2.25, size 100. |
| 4) | AXX2 offer for ABC Oct40p is 1.27, size 100. |
| 5) | CBOE offer for ABC Oct40c is 2.21, size 100. |
| 6) | CBOE offer for ABC Oct40p is 1.21, size 100. |
| 7) | Local market (e.g., CBOE) (DSM) to sell ABC Oct40c and sell |
| | Oct40p in 2:1 ratio is 5.63, size 50, which is single-exchange |
| | NBBO. |
| 8) | CBOE COB is empty. |
| 9) | OBOE receives strategy order to buy 20 ABC Oct40c and buy 10 |
| | Oct40p for $5.61 (2:1, 10 times, limit price per unit 5.61. |
| 10) | COA begins, and ends with no responses. |
| 11) | Entire order is booked, 5.61 bid for 10. |
| 12) | AXX2 Oct40c offer improves to 2.18, size 2, making the order |
| | marketable against the AXX2 Oct40c offer and either the CBOE |
| | or AXX1 Oct40p offer. |
| 13) | Before legging, COA is initiated to try to keep the order at CBOE. |
| 14) | If no COA responses are received, 1 contract executes against the |
| | CBOE Oct40p offer of 1.21 (even though AXX1 offer is better) and |
| | 2 Oct 40c contracts are linked to AXX2 at 2.18, clearing the |
| | AXX2 offer. |
| 15) | AXX2 updates Oct40c offer to 2.21, size 2, which does not yet |
| | make order marketable. |
| 16) | AXX1 improves Oct40p offer to 1.19, size 100, making order |
| | marketable with AXX1 offer in Oct40p and AXX2 offer in Oct 40c. |
| 17) | 2 contracts are linked to AXX2 to buy Oct40c for 2.21, and 1 |
| | contract is linked to AXX1 to buy Oct40p for 1.19. |

### Spread Flashing

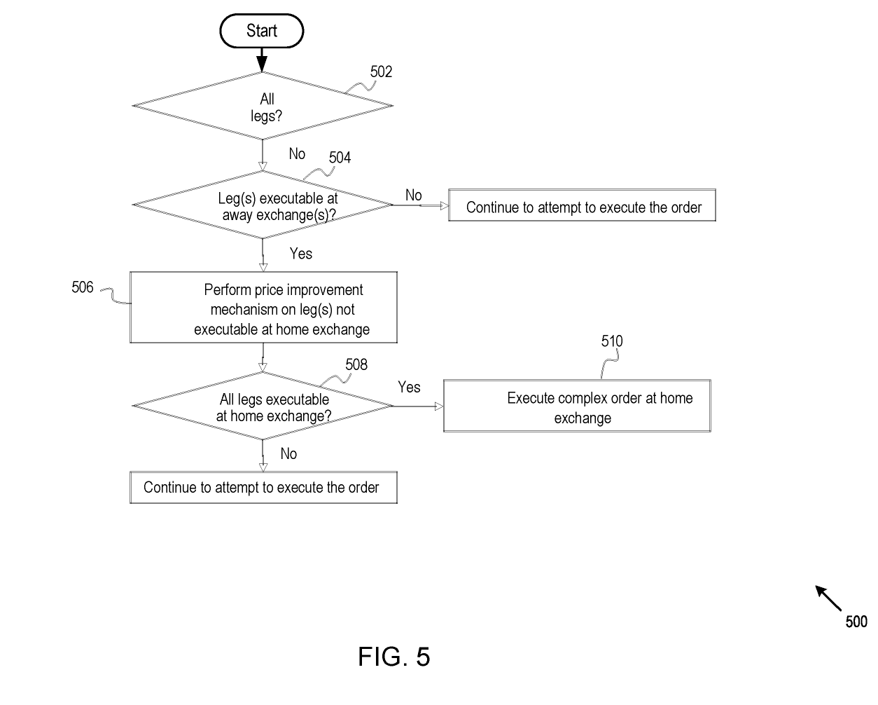

According to various embodiments of the present invention, spread flashing may allow legs of a complex order that would have been executed at an away exchange to be executed at a home exchange after the use or a price improvement mechanism. For example, FIG. 5 shows a spread flashing process as applied to the process of FIG. 4 at 420. FIG. 5 is a flow diagram showing the steps used by or system to perform spread flashing according to an embodiment of the present invention. In FIG. 5, step 406, as previously described, checks to see if all the legs of a complex order are executable at a home exchange. If not, the process continues at step 408, as previously described, which determines if any of the legs of the complex order are executable at an away exchange. If so the process continues at step 506, where a price improvement mechanism is used on the leg(s) that are not currently executable at the home exchange.

For example, CBOE's Hybrid Agency Liaison (HAL), which is the subject of U.S. Pat. No. 7,653,588, which is incorporated herein by reference, may be used to allow participants at the home exchange to “step up to” the same or better price than the price offered at the away exchange. Continuing with the description of FIG. 5, at step 508 this process determines if all of the legs of the complex order are now executable at the home exchange. If all of the legs of a complex order are now executable at the home exchange (i.e., participants at the home exchange have “stepped-up” to a price that is at or better than the NBBO), the process, at step 510, executes all of the legs of the complex order at the home exchange. If not all the legs of the complex order are executable at the home exchange, the process continues to attempt to execute the complex. For example the process could continue at step 410, as described above. home exchange

HAL is an example of a system that automates the handling of national best bid and offer (NBBO) rejects (orders received when CBOE, for example, is not on the NBBO). With HAL, market quoters at a home exchange match the NBBO within the flash period (e.g., 150 ms) or the order will be routed to an away exchange showing the best price. HAL includes those systems as described in U.S. Pat. No. 7,653,588 and Publication Nos. 20100191640 A1, both to Tilly et al., both of which are co-owned, the entire disclosures of which are hereby incorporated by reference.

According to an embodiment of the present invention, spread flash may be used prior to linking a leg to an away exchange, rather than sending a component leg of an order to an away exchange, the system initiates an auction at the home exchange intended to entice market participants at the home exchange to enter a bid or offer at a price or at a better than the away exchange. According to an embodiment of the present invention, spread flash may be used to flash one or more legs of a complex order simultaneously or in some term of an iterative process.

An example of spread flashing is as follows. A complex order having two legs is recorded having a limit price of $4. The first leg is executable at the home exchange at a price of $2, which is at the NBBO. The second leg is executable at the home exchange for a price of $2.10. Thus, the complex order is executable at the home exchange for a price of $4.10, which does not satisfy the price of the complex order. However, the price of the second leg is not at the NBBO. The second leg can have priced flash applied to it. A price improvement mechanism is applied to the second leg and a better price of $2 is obtained. The net order price is $4, which satisfies the complex order price. Had a better price not been obtained, the second leg could have been sent to an away exchange for certain at a satisfactory price, as described above. According to an embodiment of the present invention alternatively, and/or in addition to performing the spread flash on a complex order leg where, the home exchange is not at the NBBO, the home exchange may choose to flash the leg where the home exchange is on the NBBO in order to get the price improvement from that leg so that the customer's net price is a better price.

Table 5 shows the steps, according to an embodiment of the present invention, the system may use perform a spread flash upon conclusion of a COA or flashed while in COB.

TABLE 5
Spread Flash upon conclusion of COA or flash while in COB

| | |
|---|---|
| 1) | AXX1 offer for ABC Oct40c is 2.20, size 100. |
| 2) | AXX1 offer for ABC Oct40p is 1.20, size 100. |
| 3) | CBOE offer for ABC Oct40c is 2.21, size 100. |
| 4) | CBOE offer for ABC Oct40p is 1.20, size 100. |
| 5) | Local market (e.g., CBOE) (DSM) to sell ABC Oct40c and sell |
| | Oct40p in 2:1 ratio is 5.62, size 50. |
| 6) | CBOE COB is empty. |
| 7) | CBOE receives strategy order to buy 20 ABC Oct40c and buy 10 |
| | Oct40p for $5.61 (2:1, 10 times, limit price per unit 5.61. |
| 8) | COA begins, and ends with 1 response to sell 1 at 5.61. |
| 9) | 1 unit executes against COA auction response at 5.61, leaving 9 |
| | units that are not marketable at CBOE but are marketable against |
| | CBOE Oct40p offer of 1.2 and away Oct40c offer of 2.20. |
| 10) | Remaining 9 units are booked for 5 seconds. |
| 11) | Regardless of away markets, CBOE needs $.01 of improvement |
| | from the DSM. Improvement of $.01 from the Oct40p BBO would |
| | make the order exactly marketable, and improvement of $.01 from |
| | the Oct40c BBO would provide price improvement to the customer. |
| 12) | If not executed after 5 seconds, away markets are checked again. |
| | If no change, HAL is initiated in Oct40c, 18 contracts for 2.20. |
| 13) | If responses are received, executions would occur with HAL |
| | response and CBOE Oct40p offer of 1.20. Executions must occur |
| | in ratio, so if HAL response is for an odd number, 1 contract |
| | on the HAL response would be cxld. |
| 14) | If no responses are received, a HAL will be initiated on the Oct40p, |
| | 10 contracts at 1.19. If responses are received, executions would |
| | occur against the HAL responses and the CBOE Oct40c offer of |
| | 2.21, again in ratio. |
| 15) | An away market check is not actually necessary but would give |
| | some guideline to the system as to which series and at which |
| | price to flash. Other criteria may be bid/ask width |

### COB-Enhanced Execution

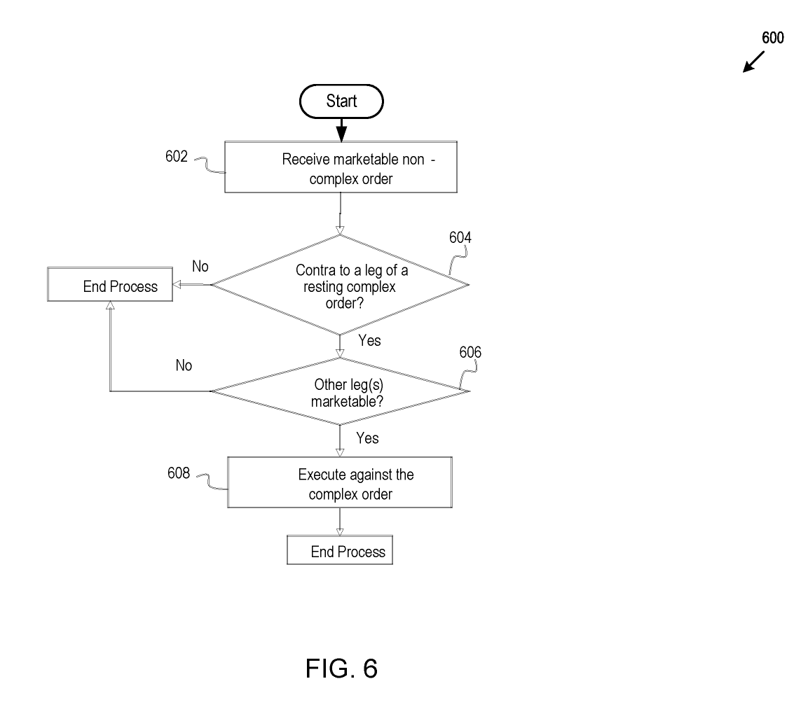

According to an embodiment of the present invention, the use of COB-Enhanced execution allows legs of a complex order that are resting on the COB to execute in a per leg basis against non-complex orders that are received at an exchange. FIG. 6 is a flow diagram showing the steps performed by a system in executing an embodiment of COB-enhanced execution according to the present invention.

At step 602, the system receives a marketable non-complex order (i.e., a single leg order). At step 604, the system determines if the received non-complex order is a contra order (i.e., an order that could fill) a leg of a complex order that is resting on the COB. If the received non-complex order is not a contra order to a leg of a complex order resting on the COB the process ends. If the received order is a contra order to a leg of a complex order resting on the COB the process continues at step 606, where the system determines if the remaining legs of the resting complex order are marketable. If the remaining legs are not marketable the process ends. If the remaining legs of the resting complex order are marketable the process continues at step 608, when the received non-complex order is executed against a leg of a resting complex order.

Table 6 shows the steps the system may use to handle a MKT and/or marketable limit order while an exchange such as CBOE is on NBBO.

TABLE 6
MKT or marketable limit order while CBOE is on NBBO

| | |
|---|---|
| 1) | CBOE on NBBO for ABC Oct40c 2.00-2.20, size 100 × 100. |
| 2) | CBOE on NBBO for ABC Oct40p 1.00-1.20, size 100 × 100. |
| 3) | CBOE COB order to sell ABC Oct40c and sell ABC Oct40p in |
| | 2:1 ratio, 6 times at 5.56. |
| 4) | Incoming order to buy 20 Oct40c at MKT (or limit of 2.20 or |
| | higher). |
| 5) | Incoming order buys 12 contracts for 2.18 from COB and 8 for |
| | 2.20 from CBOE offer. |
| 6) | COB sells 12 Oct40c at 2.18 to incoming order, and sells 6 |
| | Oct40p at 1.00 to CBOE bid (net price 5.56). Note the Oct40p |
| | trade could occur at the CBOE bid (even if off the NBBO). |

Table 7 shows the steps the system may use to handle a MKT order while an exchange such as CBOE is on NBBO, ratio check.

TABLE 7
MKT order while CBOE is on NBBO, ratio check

| 1) | CBOE on NBBO for ABC Oct40c 2.00-2.20, size 100 × 100. | |
|---|---|---|
| 2) | CBOE on NBBO for ABC Oct40p 1.00-1.20, size 100 × 100. | |
| 3) | CBOE COB order to sell ABC Oct40c and sell ABC Oct40p in | |
| | 2:1 ratio, 6 times at 5.56. | |
| 4) | Incoming order to buy 11 Oct40c at MKT. | |
| 5) | MKT order buys 10 contracts for 2.18 from COB and 1 for 2.20 | |
| | from offer.. | |
| | a. | COB sells 10 Oct40c to MKT order at 2.18 and sells 5 |
| | | Oct40p to CBOE bid at 1.00 (even if off NBBO). |

Table 8 shows the steps the system may use to handle execution of a Tweener order, ratio check.

TABLE 8
Execution of a Tweener order, ratio check

| | |
|---|---|
| 1) | CBOE on NBBO for ABC Oct40c 2.00-2.20, size 100 × 100. |
| 2) | CBOE on NBBO for ABC Oct40p 1.00-1.20, size 100 × 100. |
| 3) | CBOE COB order to sell ABC Oct40c and sell ABC Oct40p in 2:1 |
| | ratio, 6 times at 5.56. |
| 4) | Incoming order to buy 11 Oct40c at 2.19 |
| 5) | Incoming order buys 10 contracts for 2.18 from COB (price |
| | improvement), and remainder of 1 is booked at 2.19. |
| 6) | COB sells 10 Oct40c at 2.18 to incoming order, and sells 5 Oct40p |
| | at 1.00 to CBOE bid (even if off NBBO). |

Table 9 shows the steps the system may use to handle execution of a NBBO rejected order.

TABLE 9
Execution of a NBBO rejected order

| | |
|---|---|
| 1) | CBOE off NBBO offer for ABC Oct40c 2.00-2.21, size 100 × 100 |
| | (NBBO offer 2.18, size 100). |
| 2) | CBOE on NBBO for ABC Oct40p 1.00-1.20, size 100 × 100. |
| 3) | CBOE COB order to sell ABC Oct40c and sell ABC Oct40p in 2:1 |
| | ratio, 6 times at 5.56. |
| 4) | Incoming order to buy 11Oct40c at MKT (or limit of 2.18 or |
| | higher). |
| 5) | Incoming order buys 10 contracts for 2.18 from COB and remainder |
| | of 1 is HAL'd at NBBO of 2.18. |
| 6) | COB sells 10 Oct40c to incoming order at 2.18 and sells 5 Oct40p |
| | to CBOE bid at 1.00 (even if off NBBO). |

### Synthetic Quote

According to an embodiment of the present invention, system 202, in an effort to fill complex orders, may generate one or more synthetic quotes having an improved calculated price. The system calculates synthetic quotes for one or more legs of a complex order resting on the COB to attract simple orders that are tradable against the resting complex order.

An exchange may receive a complex order and utilize one or more techniques in order to fill the complex order. According to an embodiment of the present invention, techniques that may be used include, but are not limited to: spread linking, spread legging, and spread flash (as describe above). Generally, complex orders that are not filled are placed on the COB, where the complex order waits for execution.

According to an embodiment of the present invention, in order to increase the likelihood that a complex order resting on the COB is filled, an exchange may use a net price of the complex order to display a better price for one or more legs of the complex order. In some implementations, an exchange may deconstruct a complex order resting on the COB and advertise a new display price for a component leg of the complex order that makes the complex order executable.

According to an embodiment of the present invention, the new display price for the component leg is equal to or better than a previously displayed price for the component leg. The new display price for the component leg is typically a price that the exchange has determined to be executable. Further, the new display price for the component leg results in a net price for the complex order that is the same as the net price of the complex order with the original price for the leg of the complex order.

In some implementations, an exchange may automatically deconstruct a complex order and generate (by imputed instruction, saved preferences, or automatically according system settings) a synthetic quote for one or more legs of the complex order. The synthetic quote matches or improves upon the best-displayed bid or offer on the order book for the leg of the complex order. The synthetic quote of the complex order additionally results in a net price that satisfies the complex order at their original prices. This, according to some embodiments, may result in improved liquidity for complex orders.

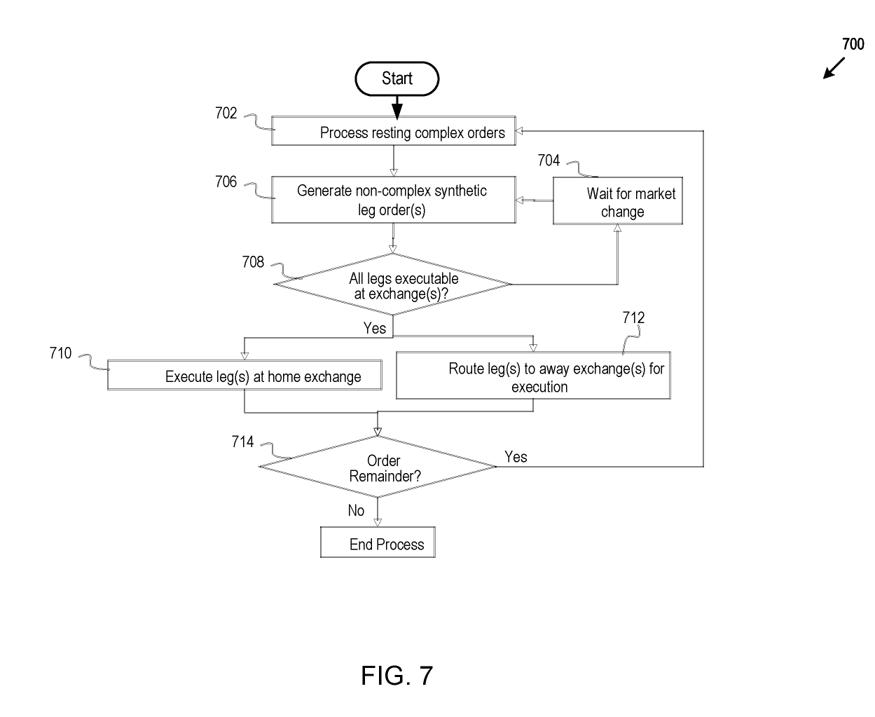

FIG. 7 is a flow diagram showing the steps performed by a system in calculating and displaying synthetic quotes, according to an embodiment of the present invention. At step 702, the system processes orders resting on the COB. According to an embodiment of the present invention, this processing includes the step of determining if the order is priced within the leg market. That is, if the legs were each executed separately, could the order be executed for a satisfactory price (i.e., a price that meets to the complex order limit price). At step 706, the system generates one or more synthetic COB leg quotes.

According to an embodiment of the present invention, the system may determine which leg(s) of a complex order to create a synthetic quote for by analyzing various factors and information about each leg of the complex order. For example, the system may analyze the bids/offers for a leg, an aggregate number of bid or offers associated with a leg, a liquidity of a leg, a price movement of a leg, and/or any other factor that may help a system such as an exchange identify a leg for the creation of a synthetic COB quote.

According to an embodiment of the present invention, a synthetic quote may be generated according to the following steps. Using a system to determine, in real-time, the difference between the limit price and the market for a complex order. Creating synthetic quotes on one or more of the legs of the complex order in the non-complex order book by adjusting the current BBO of the legs by the difference between the limit price and the market for a complex order. For a detailed example, see Table 10 below.

After generation, a synthetic COB quote for each leg may be checked to determine whether the synthetic COB quote will attract simple orders that make the resting complex orders tradable and updated each time the synthetic COB quote is updated.

At step 708, the system determines whether all legs of an order may be executable by an exchange (e.g., the home exchange or one or more away exchanges). When the component legs of the order cannot be executed by an exchange, the system waits for a market change at step 704. Once a market change occurs, the process loops to step 706 and the system generates one or more synthetic COB leg quotes as described above.

However, when the system determines at step 708 that the component legs of the order can be executed by an exchange, at step 710, the home exchange executes the component legs of the order executable at the home exchange. Additionally, at step 712, the system communicates the other component legs of the order to the one or more away exchanges for execution at the one or more away exchanges.

At step 714, the system determines whether an order remainder exists. When the system determines that an order remainder exists, the process loops to step 702 and the above-described process is repeated for the remainder. However, when the system determines at step 714 that an order remainder does not exist, the process ends.

In some implementations, the system may use a priority scheme to rank and/or prioritize the various methods for processing complex orders and determine when to calculate synthetic COB quotes for legs of multi-legged complex orders. The rank and/or priority of methods for processing complex orders may be in direct correlation to an amount of risk exposure and/or price improvement that may result from each of the various methods.

In one example, a system may perform spread linking prior to performing spread legging in order to execute an order. The system may receive no interest in a calculated synthetic price in leg one, and subsequently initiate flashing in the second leg of a multi-legged order. In another example, a system may receive no interest in a calculated synthetic price in leg one, but the exchange may receive an order for the second leg. Since the spread exists, the system may use COB execution to fill the incoming order for the second leg even though no synthetic price may be shown for the second leg. The incoming order may be shown against the second leg of the resting COB order, while leg one of the resting cob order may fill against the displayed local market (e.g., CBOE). In some implementations, a graphical indicator may indicate whether the system has calculated a synthetic price for a leg resting on the COB.

In some implementations, in the event a spread order is resting on the COB that includes an order to buy series one and sell series two, a system may create a synthetic price for series one. The system may flag the displayed market in the series two so that users are notified that a spread exists with a component leg with a synthetic price. A spread with a synthetic COB price for a component leg may be an enticement that encourages more incoming single-legged orders. The enticement is created because of an expectation that such a spread may provide price improvement from the displayed market. When the system displays a price for a leg of a complex order that is not synthetic, the system may graphically indicate whether the leg is part of a spread with another leg at a synthetic COB price. Such an indication may also encourage more incoming single-legged orders because of an expectation that such a spread may provide price improvement from the displayed market.

Table 10 includes the steps the system may use when calculating synthetic COB quotes for a user.

TABLE 10
When to calculate Synthetic COB Quotes for a user

| | |
|---|---|
| 1) | CBOE (Exchange) ABC (Ticker) Oct40c (Option Class) 2.00-2.20 |
| | (BBO), size 100 × 100. |
| 2) | CBOE ABC Oct40p 1.00-1.20, size 100 × 100. |
| 3) | CBOE DSM 5.00-5.60, size 50 × 50. |
| 4) | CBOE COB order to sell ABC Oct40c and sell ABC Oct40p in 2:1 |
| | ratio, 6 times at 5.56 (inside DSM by .04). |
| 5) | Synthetic quote(s) created .04 inside one or possibly both BBOs. |
| 6) | New “synthetic-enhanced” SBBO for Oct40c 2.00-2.18, size |
| | 100 × 12. |
| 7) | New “synthetic-enhanced” SBBO for Oct40p 1.00-1.16, size |
| | 100 × 6. |
| 8) | Incoming order to buy 5 Oct40c MKT. |
| 9) | Incoming order trades 4 at 2.18 with COB and 1 at 2.20 with offer. |
| | Note, entire synthetic offer of 2.18 must be cleared upon execution |
| | of 4 contracts because the remaining 1 contract of the incoming |
| | order must execute at 2.20, which is outside the SBBO. |
| 10) | COB order sells 4 Oct40c at 2.18 to incoming order, and sells 2 |
| | Oct40p at 1.00 to bid. |
| 11) | If above demonstration of ratio effect causes rule concern, we may |
| | display SBBOs only for 1-by-1 COBs. |
| 12) | If we choose to display SBBO only for 1 leg, criteria must be |
| | created, such as (A) choose series where CBOE is off NBBO and |
| | SBBO would match or improve NBBO; (B) choose series with |
| | widest Bid/ask width; (C) other. |

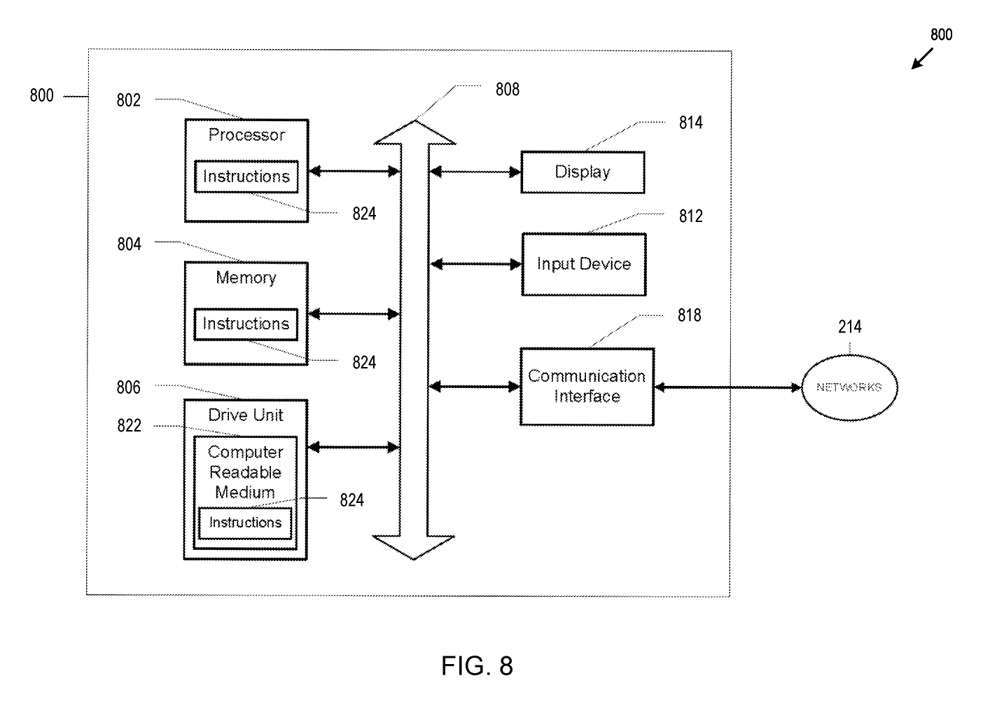

FIG. 8 is an illustrative example of an embodiment of a general computer system 800 usable for handling complex orders. The computer system 800 may include a processor 802, such as, a central processing unit (CPU), a graphics processing unit (GPU), or both. The processor 802 may be a component in a variety of systems. For example, the processor 802 may be part of a standard personal computer or a workstation. The processor 802 may be one or more general processors, digital signal processors, application specific integrated circuits, field programmable gate arrays, servers, networks, digital circuits, analog circuits, combinations thereof, or other now known or later developed devices for analyzing and processing data. The processor 802 may implement a software program, such as code generated manually (i.e., programmed).

The computer system 800 may include a memory 804 that can communicate via a bus 808. The memory 804 may be a main memory, a static memory, or a dynamic memory. The memory 804 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 804 may include a cache or random access memory for the processor 802. Alternatively or in addition, the memory 804 may be separate from the processor 802, such as a cache memory of a processor, the system memory, or other memory. The memory 804 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 804 may be operable to store instructions 824 executable by the processor 802. The functions, acts or tasks illustrated in the figures or described herein may be performed by the programmed processor 802 executing the instructions 824 stored in the memory 804. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 800 may further include a display 814, such as a liquid crystal display (LCD), an organic light emitting diode (OLED), a flat panel display, a solid state display, a cathode ray tube (CRT), a projector, a printer or other now known or later developed display device for outputting determined information. The display 814 may act as an interface for the user to see the functioning of the processor 802, or specifically as an interface with the software stored in the memory 804 or in the drive unit 806.

Additionally, the computer system 800 may include an input device 812 configured to allow a user to interact with any of the components of system 800. The input device 812 may be a number pad, a keyboard, or a cursor control device, such as a mouse, or a joystick, touch screen display, remote control or any other device operative to interact with the system 800.

The computer system 800 may also include a disk or optical drive unit 806. The disk drive unit 806 may include a computer-readable medium 822 in which one or more sets of instructions 824, e.g. software, can be embedded. Further, the instructions 824 may perform one or more of the methods or logic as described herein. The instructions 824 may reside completely, or at least partially, within the memory 804 and/or within the processor 802 during execution by the computer system 800. The memory 804 and the processor 802 also may include computer-readable media as discussed above.

The present disclosure contemplates a computer-readable medium 822 that includes instructions 824 or receives and executes instructions 824 responsive to a propagated signal; so that a device connected to a network 214 may communicate voice, video, audio, images or any other data over the network 214. Further, the instructions 824 may be transmitted or received over the network 214 via a communication interface 818. The communication interface 818 may be a part of the processor 802 or may be a separate component. The communication interface 818 may be created in software or may be a physical connection in hardware. The communication interface 818 may be configured to connect with a network 214, external media, the display 814, or any other components in system 800, or combinations thereof. The connection with the network 214 may be a physical connection, such as a wired Ethernet connection or may be established wirelessly as discussed below. Likewise, the additional connections with other components of the system 800 may be physical connections or may be established wirelessly.

The network 214 may include wired networks, wireless networks, or combinations thereof. The wireless network may be a cellular telephone network, an 802.11, 802.16, 802.20, or WiMax network. Further, the network 214 may be a public network, such as the Internet, a private network, such as an intranet, or combinations thereof, and may utilize a variety of networking protocols now available or later developed including, but not limited to TCP/IP based networking protocols.

The computer-readable medium 822 may be a single medium, or the computer-readable medium 822 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 822 may include a solid-state memory such as a memory card or other package that houses one or more non-volatile read-only memories. The computer-readable medium 822 also may be a random access memory or other volatile re-writable memory. Additionally, the computer-readable medium 822 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

It is intended that the foregoing detailed description be regarded as illustrative rather than limiting, and that it be understood that it is the following claims, including all equivalents, that are intended to define the spirit and scope of this invention.

1.-14. (canceled)

15. An electronic trading platform, comprising:
a memory for storing a set of instructions and a complex order comprising multiple legs and associated with a requested net price;
at least one processor in communication with the memory, the at least one processor, when executing the set of instructions, configured to cause the trading platform to:
obtain market data for the multiple legs;
determine that the requested net price for the complex order is not satisfied based on the market data for the multiple legs;
deconstruct the complex order and select a subset of legs of the multiple legs based on market activities for the multiple legs;
generate one or more synthetic quotes for the subset of legs comprising quoted prices, wherein the quoted prices for the one or more synthetic quotes are derived from the market activities of the subset of legs and wherein a combination of the quoted prices and market prices of remaining legs provides a net price that satisfies the requested net price;
transmit the one or more synthetic quotes to market participants;
determine whether the one or more synthetic quotes are marketable; and
execute the complex order by executing the one or more synthetic quotes at the quoted prices and the remaining legs at the market prices.

16. The trading platform of claim 15, wherein:
the one or more synthetic quotes are transmitted to the market participants via multiple independent exchanges; and
the complex order are executed by the multiple independent exchanges.

17. The electronic trading platform of claim 15, wherein the at least one processor, when executing the set of instructions, before causing the electronic trading platform to execute the complex order, is configured to cause the electronic trading platform to determine that the quoted prices of the one or more synthetic quotes and updated market prices of the remaining legs provides a net price that satisfies the requested net price.

18. The electronic trading platform of claim 15, wherein the at least one processor, when executing the set of instructions, is further configured to cause the electronic trading platform to:
determine whether an order remainder results from execution of the complex order; and
rest the order remainder at the electronic trading platform when the order remainder results.

19. The electronic trading platform of claim 15, wherein at least one synthetic quote of the one or more synthetic quotes is a complex quote comprising more than one leg and a net quoted price for the more than one leg.

20. The electronic trading platform of claim 19, wherein:
the one or more synthetic quotes are transmitted to the market participants via multiple independent exchanges; and
the complex order are executed by the multiple independent exchanges.

21. A method performed by an electronic trading platform to trade a complex order comprising multiple legs and a requested net price, the method comprising:
obtaining market data for the multiple legs;
determining that the requested net price for the complex order is not satisfied based on the market data for the multiple legs;
deconstructing the complex order and selecting a subset of legs of the multiple legs based on market activities for the multiple legs;
generating one or more synthetic quotes for the subset of legs comprising quoted prices, wherein the quoted prices for the one or more synthetic quotes are derived from the market activities of the subset of legs and wherein a combination of the quoted prices and market price of remaining legs provides a net price that satisfies the requested net price;
transmitting the one or more synthetic quotes to market participants;
determining whether the one or more synthetic quotes are marketable; and
executing the complex order by executing the one or more synthetic quotes at the quoted prices and the remaining legs at the market prices.

22. The method of claim 21, wherein:
the one or more synthetic quotes are transmitted to the market participants via multiple independent exchanges; and
the complex order are executed by the multiple independent exchanges.

23. The method of claim 21, before executing the complex order, further comprising determining that the quoted prices of the one or more synthetic quotes and updated market prices of the remaining legs provides a net price that satisfies the requested net price.

24. The method of claim 21, further comprising:
determining whether an order remainder results from execution of the complex order; and
resting the order remainder at the electronic trading platform when the order remainder results.

25. The method of claim 21, wherein at least one synthetic quote of the one or more synthetic quotes is a complex quote comprising more than one leg and a net quoted price for the more than one leg.

26. The method of claim 25, wherein:
the one or more synthetic quotes are transmitted to the market participants via multiple independent exchanges; and
the complex order are executed by the multiple independent exchanges.
